(19) United States
(12) Patent Application Publication
(10) Pub. No.: US 2007/0160250 A1
(43) Pub. Date: Jul. 12, 2007

(54) Wireless headphone

(75) Inventor: Ching-Chang Kuo, Kaohsiung City (TW)

Correspondence Address: TROXELL LAW OFFICE PLLC, SUITE 1404, 5205 LEESBURG PIKE, FALLS CHURCH, VA, 22041, US

(73) Assignee: JAKI ELECTRONIC (SHENZHEN) CO., LTD.

(21) Appl. No.: 11/326,469

(22) Filed: Jan. 6, 2006

(51) Int. Cl. H04R 25/00

(52) U.S. Cl. 381/371; 381/370

(57) ABSTRACT

Provided is a wireless headphone including two earphones each including a plate, a housing, a cap for securing the housing to the plate, a winding mechanism provided in the plate, and a cable wound in the winding mechanism and having a male plug at one end; and a playing device (e.g., MP4 player) fastened on the plate of either earphone by the cap, the playing device including a female port adapted to securely, matingly receive the male plug. Pulling the playing device with the cable being pulled resiliently will enable a user to listen to music and/or watch pictures shown on the playing device. A further pulling of the playing device or the cable will retract the playing device to engage with the earphone.

### BACKGROUND OF THE INVENTION

1) Field of Invention

The present invention relates to wireless headphones and more particularly to such a wireless headphone having an electronic device (e.g., MP4 player, MP3 player, or radio) built thereinto with improved characteristics.

2) Related Art

A present benefit enjoyed by present day society is the availability of music and movies. There is one type of wireless headphone having, for example, MP4 player or MP3 player built thereinto. Conventionally, a connector cable is interconnected a port of the headphone and a port of the player.

However, the prior art suffered from several disadvantages. For example, the cable may wildly swing when a user is walking or is engaging in physical exercise. Further, the wildly swung cable may entangle other objects especially in a crowded place. Furthermore, the user has to remove the MP3 player by disengaging the cable with the port prior to adjusting volume or skipping to another song. Thus, the user may temporarily not be able to listen to the music. Alternatively, the user may temporarily not be able to see pictures shown on the screen when a MP4 player is playing. Thus, the need for improvement still exists.

### SUMMARY OF THE INVENTION

It is therefore an object of the present invention to provide a wireless headphone comprising two earphones each including a plate, a housing, a cap for securing the housing to the plate, a winding mechanism provided in the plate, and a cable wound in the winding mechanism and having a male plug at one end; and a playing device fastened on the plate of either earphone by the cap, the playing device including a female port adapted to securely, matingly receive the male plug; whereby pulling the playing device with the cable being pulled resiliently will enable a user to listen to music and/or watch pictures shown on the playing device, and a further pulling of the playing device or the cable will retract the playing device to engage with the earphone.

In one aspect of the present invention the winding mechanism comprises a disk, a fastening member, an annular frame formed on the disk with the wound cable rested therein, and a central hole through the disk.

The above and other objects, features and advantages of the present invention will become apparent from the following detailed description taken with the accompanying drawings.

### BRIEF DESCRIPTION OF THE DRAWINGS

FIG. 1 is a partial exploded view of an earphone unit of a wireless headphone according to the invention;

FIG. 2 is an exploded view of FIG. 1;

FIG. 3 is another exploded view of FIG. 1 taken opposing the FIG. 2;

FIG. 4 is a perspective view of a complete wireless headphone according to the invention; and

FIG. 5 is view similar to FIG. 4 showing the MP4 player being pulled.

### DETAILED DESCRIPTION OF THE INVENTION

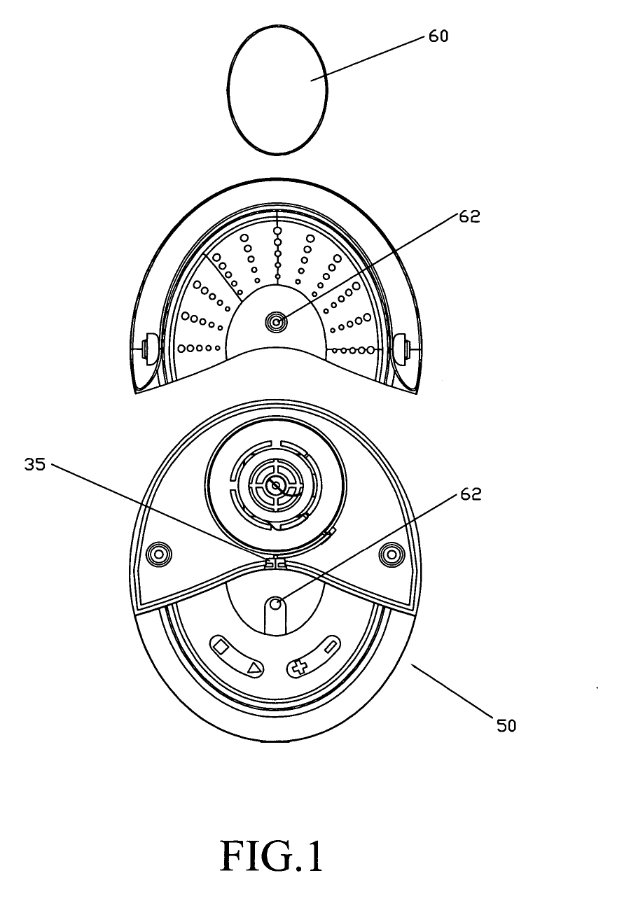

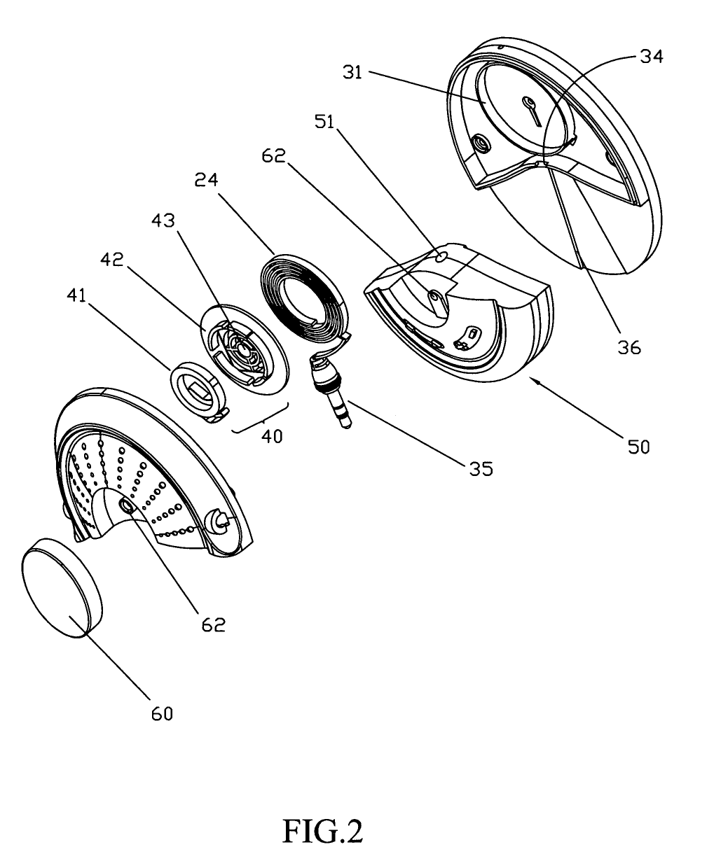

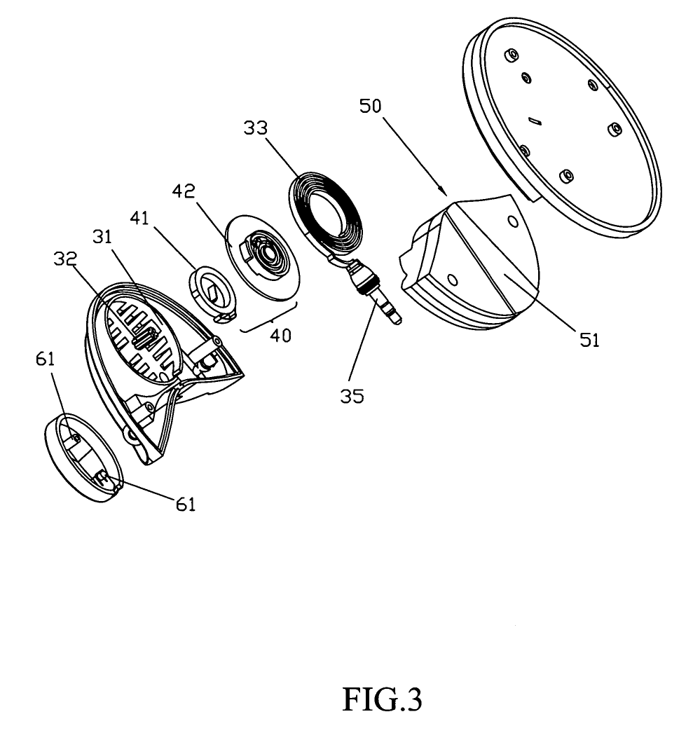

Referring to FIGS. 1 to 4, a wireless headphone in accordance with a preferred embodiment of the invention is shown. A MP4 player 50 has its female port 51 being adapted to securely, matingly receive a male plug 35. A cable 33 is wound concentrically. A disk shaped winding mechanism 40 comprises a fastening member 41, an annular frame 43 on the disk with the wound cable 33 rested therein, and a central hole 43 through the disk. The cable 33 passes a central hole 34 of a plate 31 to have its one end fixedly connected to the plug 35. Two pins 61 on an inner surface of a cap 60 are adapted to insert into a hole 62 of a half circular earphone housing and a hole 62 of the MP4 player 50 respectively. This completes the assembly of the MP4 player 50 in the wireless headphone.

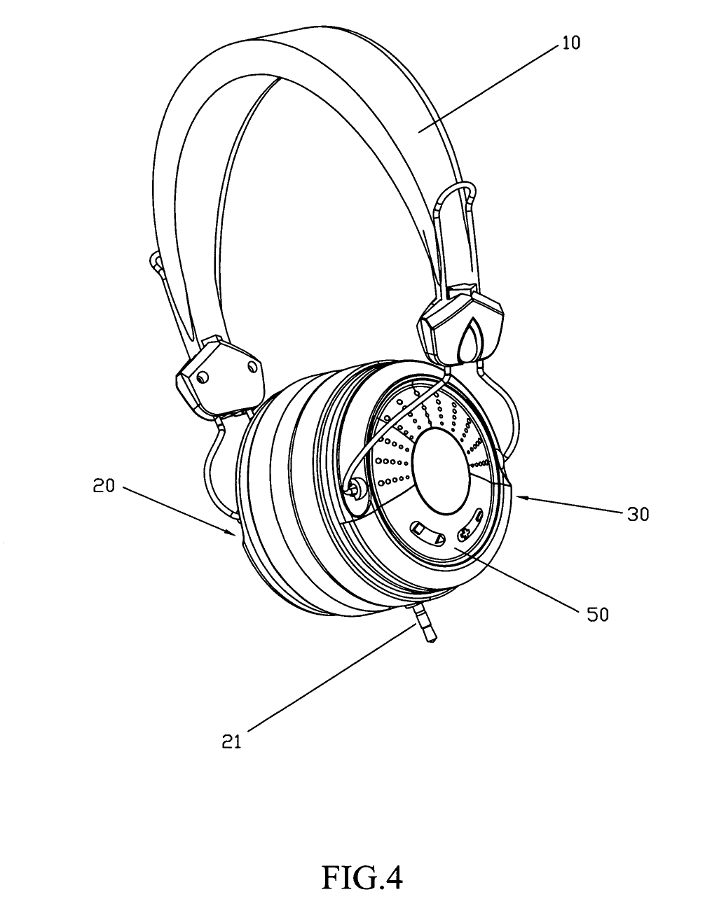

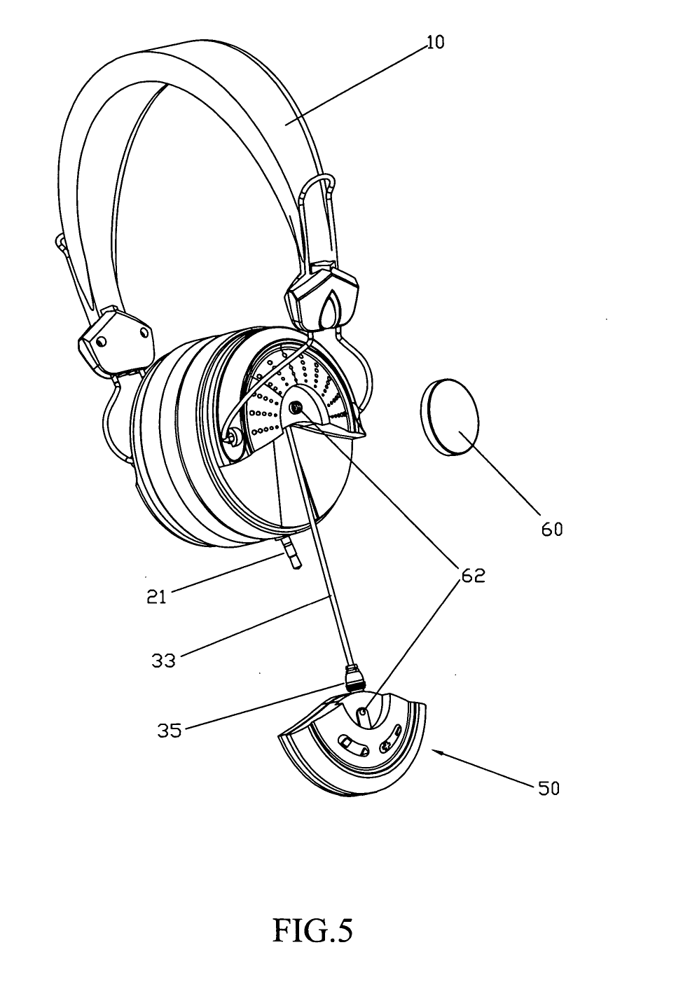

Referring to FIGS. 4 and 5 in conjunction with FIGS. 1 to 3, the wireless headphone comprises two earphones 20 and 30 and an arc-shaped band 10 interconnecting the earphones 20 and 30. The band 10 is adapted to put over the head. One earphone 20 has a male plug 21 extended therefrom. The MP4 player 50 comprises a raised member 52 adapted to matingly engage with a groove 36 of the plate 31 (i.e., the MP4 player 50 and the plate 31 are secured together). The cap 60 is securely fitted on the other earphone 30. Thus, the MP4 player 50 and the other earphone 30 are secured together. Note that the wireless headphone may assemble with MP3 player, radio, or the like in other embodiments rather than with the MP4 player as shown and illustrated in the preferred embodiment.

As shown in FIG. 5 specifically, for adjusting volume or skipping to another song, a user may pull the MP4 player 50 and thus pull the cable 33 resiliently to a desired length rather than unplugging the male plug 35 from the MP4 player 50. As such, the user may continue to listen to music and/or watch pictures shown on the screen. A further slight pulling of the MP4 player 50 or the cable 33 will automatically retract the MP4 player 50 to engage with the other earphone 30 in its original position.

While the invention herein disclosed has been described by means of specific embodiments, numerous modifications and variations could be made thereto by those skilled in the art without departing from the scope and spirit of the invention set forth in the claims.

What is claimed is:

1. A wireless headphone comprising:
two earphones each including a plate, a housing, a cap for securing the housing to the plate, a winding mechanism provided in the plate, and a cable wound in the winding mechanism and having a male plug at one end; and
a playing device fastened on the plate of either earphone by the cap, the playing device including a female port adapted to securely, matingly receive the male plug;
whereby pulling the playing device with the cable being pulled resiliently will enable a user to listen to music and/or watch pictures shown on the playing device, and a further pulling of the playing device or the cable will retract the playing device to engage with the earphone.

2. The wireless headphone of claim 1, wherein the winding mechanism comprises a disk, a fastening member, an annular frame formed on the disk with the wound cable rested therein, and a central hole through the disk.
